(19) United States
(12) Patent Application Publication
(10) Pub. No.: US 2026/0008015 A1
(43) Pub. Date: Jan. 8, 2026

(54) Membrane Distillation Assembly

(71) Applicant: NSS Water Enhancement Technology AB, Bengtsfors (SE)

(72) Inventor: Björn Holmström, Karlstad (SE)

(21) Appl. No.: 18/712,956

(22) PCT Filed: Nov. 21, 2022
(86) PCT No.: PCT/EP2022/082546

§ 371 Date: May 23, 2024

(30) Foreign Application Priority Data
Nov. 24, 2021 (SE) 2151427-8

(51) Int. Cl. B01D 61/36; C02F 1/44

(52) U.S. Cl. CPC B01D 61/366; B01D 61/364; C02F 1/447; B01D 2313/083; B01D 2313/18; B01D 2313/22; B01D 2313/501; C02F 2201/005; C02F 2209/03; C02F 2209/40; C02F 2301/043; C02F 2301/046

(57) ABSTRACT

A membrane distillation assembly for providing purified water, the membrane distillation assembly including a membrane distiller that is configured for producing purified water, the membrane distiller having an evaporation chamber and a condensation chamber, wherein the evaporation chamber and the condensation chamber are separated from each other by a membrane, a reservoir connected to the membrane distiller, the reservoir being configured for intermediate storing of purified water, a water supply unit connected to the membrane distiller, and a purified water dispenser tool connected to the reservoir. The membrane distillation assembly wherein the reservoir includes at least two tanks for intermediate storing of purified water, wherein said tanks are connected in parallel with each other between the membrane distiller and the purified water dispenser tool.

### CROSS-REFERENCE TO RELATED APPLICATIONS

This application is the United States national phase of International Patent Application No. PCT/EP2022/082546 filed Nov. 21, 2022, and claims priority to Swedish Patent Application No. 2151427-8 filed Nov. 24, 2021, the disclosures of which are hereby incorporated by reference in their entireties.

### BACKGROUND OF THE INVENTION

### Field of the Invention

The present invention relates in general to a membrane distillation assembly configured for removing particles from water, i.e. producing purified water, to be used in industrial applications, and temporary/intermediate storing of the purified water. More precisely the present invention relates to a membrane distillation assembly capable of producing nano/ultra-purified water that does not comprise any particles greater than 10 nanometers.

The present invention relates in particular to a membrane distillation assembly for providing purified water, the membrane distillation assembly comprising:
a membrane distiller that is configured for producing purified water, the membrane distiller having an evaporation chamber and a condensation chamber, wherein the evaporation chamber and the condensation chamber are separated from each other by a membrane,
a reservoir connected to the membrane distiller, the reservoir being configured for intermediate storing of purified water,
a water supply unit connected to the membrane distiller, and
a purified water dispenser tool connected to the reservoir.

Such membrane distillation assemblies are especially useful in the semiconductor manufacturing industry, wherein the semiconductor wafers are passing several washing steps using purified water.

### Description of Related Art

The present invention is based on the fact that the semiconductors are getting smaller and smaller to meet the requests for faster and less expensive electronics consuming less energy. Thus, the semiconductors/structures on the silicon wafers becomes smaller and the distances between them becomes smaller in order to have the wafers comprising more semiconductors/structures. Thus, the demand for more efficient washing of the wafers from also very small contaminations increase in order to prevent short-circuiting and malfunction of the semiconductors, and thereto the water used has to be ultra-purified water in order to not have the water contaminate the wafers. The washing of wafers consumes large volumes of ultra-purified water in order to obtain the requested washing result, however the production of ultra-purified water is time consuming and energy demanding and the useful life of produced ultra-purified water is short, i.e. less than 30 minutes. Thereto, transportation of purified water in tanks or pipes give rise to contaminations, i.e. based on growth of present contaminations and based on addition of contaminations from the materials of the tank/pipes. Known membrane distillation assemblies does not manage to produce the requested volume of purified water, since known technique is too slow.

Thus, there is a need for an apparatus configured for efficient production of large volumes of ultra-purified water close to the site of utilization, i.e. at the washing station in the clean room, at the time of utilization. In addition to using the purified water as detergent, it may also be used as a solvent in different industrial applications.

### OBJECT OF THE INVENTION

The aim of the present invention is to set aside the drawbacks and shortcomings of the previously known membrane distillation assemblies and to provide an improved membrane distillation assembly. A primary object of the present invention is to provide an improved membrane distillation assembly of the initially defined type that provides the requested volumes of purified water at all times and that can be used in the clean room of a semiconductor/wafer manufacturing plant. It is another object of the present invention to provide a membrane distillation assembly, wherein the production and the utilization of the purified water can be made concurrently and continuously. It is another object of the present invention to provide a membrane distillation assembly, wherein the degree of purification of the purified water is increased and thereby the requested volume of purified water decrease. It is another object of the present invention to provide a membrane distillation assembly, consuming less tap water.

### SUMMARY OF THE INVENTION

According to the invention at least the primary object is attained by means of the initially defined membrane distillation assembly having the features defined in the independent claim. Preferred embodiments of the present invention are further defined in the dependent claims.

According to the present invention, there is provided a membrane distillation assembly of the initially defined type, which is characterized in that the reservoir comprises at least two tanks for intermediate storing of purified water, wherein said tanks are connected in parallel with each other between the membrane distiller and the purified water dispenser tool.

Thus, the present invention is based on the insight of having a design/construction of the reservoir managing to supply ultra-purified water just-in-time at the site of utilization, i.e. the said at least two tanks are filled alternately and supplies ultra-purified water to the dispenser tool alternately. Thus, the production and the utilization can be made concurrently and continuously.

According to various embodiments of the invention, each tank comprises an intermediate conduit connected to the membrane distiller and having a controllable inlet intermediate valve, and an outlet conduit connected to the purified water dispenser tool and having a controllable outlet valve. Thereby, the separate tanks of the reservoir may be individually filled and emptied. Further, each tank comprises a discharge conduit having a controllable discharge valve, wherein the discharge conduit bypasses the dispenser tool. Thereby any old/unsuitable water of a separate tank may be discharged or recirculated without affecting the supply of purified water to the dispenser tool.

According to various embodiments of the invention, the water supply unit connected to the membrane distiller comprises a primary water supply conduit connected to the evaporation chamber, wherein the primary water supply conduit comprises a heater. Thereby the water to be treated/purified has the appropriate/correct temperature already when reaching the evaporation chamber.

According to various embodiments of the invention, the membrane distiller comprises a cooling chamber located adjacent the condensation chamber. Thereby appropriate and efficient cooling of the condensation chamber is attained.

Further advantages with and features of the invention will be apparent from the other dependent claims as well as from the following detailed description of preferred embodiments.

### BRIEF DESCRIPTION OF THE DRAWINGS

The terms FIG., FIGS., FIGURE, and FIGURES are used interchangeably in the specification to refer to the corresponding figures in the drawings.

A more complete understanding of the abovementioned and other features and advantages of the present invention will be apparent from the following detailed description of preferred embodiments in conjunction with the appended drawings, wherein:

FIG. 1 is a schematic illustration of the main components of a membrane distillation assembly,

FIG. 2 is a schematic illustration of a reservoir of the membrane distillation assembly according to a first embodiment,

FIG. 3 is a schematic illustration of a reservoir of the membrane distillation assembly according to a second embodiment, and

FIG. 4 is a schematic illustration of a water supply unit of the membrane distillation assembly.

### DESCRIPTION OF THE INVENTION

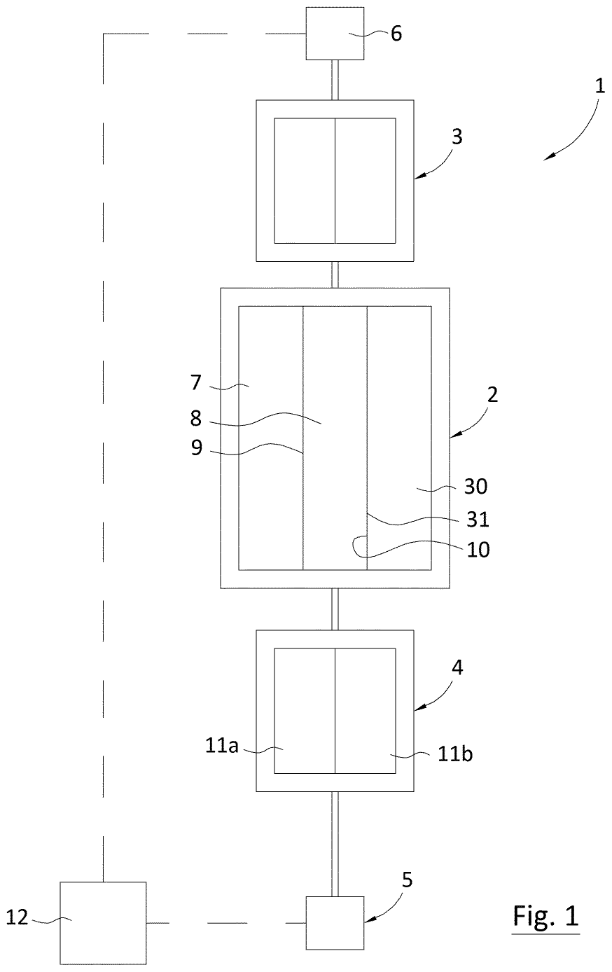

Reference is initially made to FIG. 1 disclosing a schematic illustration of the main components of a membrane distillation assembly, generally designated 1.

The membrane distillation assembly 1 comprise a membrane distiller 2 that is configured for producing purified water, i.e. ultra-clean water, a water supply unit 3 connected to the membrane distiller 2 and configured to supply the water to be treated to the membrane distiller 2, a reservoir 4 connected to the membrane distiller 2 and configured to receive the purified water from the membrane distiller 2, and a purified water dispenser tool 5 connected to the reservoir 4. The reservoir 4 is configure for intermediate/temporary storing the purified water.

The water supply unit 3 is connected to a water source 6, for instance the water mains, i.e. tap water. The purified water dispenser tool 5 may be a manually operated nozzle/handle or an automatically controlled nozzle.

The membrane distiller 2 comprises a sealed evaporation chamber 7 and a sealed condensation chamber 8, wherein the evaporation chamber 7 and the condensation chamber 8 are separated from each other by a membrane 9. The condensation chamber 8 is also known as gas chamber. According to various embodiments the membrane distiller 2 comprises multiple sets of evaporation chambers 7 and condensation chambers 8, wherein such sets are arranged in parallel to each other. Preferably each evaporation chamber 7 is associated with two condensation chambers 8, wherein the condensation chambers 8 are arranged opposite each other, one on each side of the evaporation chamber 7. The membrane 9 has a pore size equal to or less than 1000 nanometres, preferably equal to or less than 750 nanometres, most preferably equal to or less than 500 nanometres. The membrane 9 has a pore size equal to or greater than 100 nanometres. A smaller pore size provides in general a cleaner water but at the same time the production of purified water becomes slower. The pores must be small enough to prevent liquid penetration.

The water supply unit 3 supply water to the condensation chamber 7, i.e. the evaporation chamber 7 is filled with warm water, e.g. equal to or more than 80 degrees Celsius and equal to or less than 90 degrees Celsius. The water as such cannot penetrate the membrane 9 but vapour at the interface between the water and the membrane 9 will penetrate through the membrane 9 into the condensation chamber 8, and leaving contaminations in the evaporation chamber 7. The temperature in the condensation chamber 8 is lower than temperature in the evaporation chamber 7, i.e. the evaporation chamber 8 is cooled, and the vapour will accumulate/condense into droplets in the condensation chamber 8. The condensation chamber 8 comprises a cold surface 10 against which a more efficient condensation of the vapour takes place. The droplets will accumulate and finally flow to the bottom of the condensation chamber 8, and therefrom the purified water will exit the membrane distiller 2 and enter the reservoir 4. The pressure difference between the evaporation chamber 7 and the condensation chamber 8 is equal to or less than 0.5 bar, i.e. the water must not be forced/pressed through the membrane 9.

The membrane 9 shall be manufactured from a thermally and chemically stable material, and preferably a hydrophobic material, such as polytetrafluoroethylene [PTFE], polypropylene [PP], polyvinylidene fluoride [PVDF], etc.

The reservoir 4 comprises at least two tanks 11a, 11b for intermediate/temporary storing of purified water. The tanks 11a, 11b are connected in parallel with each other between the membrane distiller 2 and the purified water dispenser tool 5. During operation of the membrane distillation assembly 1, the first tank 11a is filled with purified water from the membrane distiller 2 and the second tank 11b supply purified water to the dispenser tool 5, and vice versa. Thereby the production and the utilization of purified water may take place concurrently and continuously.

It shall be pointed out that the first tank 11a does not need to be completely filled up before the purified water from the first tank 11a is utilized, and vice versa. Preferably the first tank 11a is filled to a degree/extent that equals the demand for purified water at the dispenser tool 5 during the time it takes to fill up the second tank 11b, etc.

The purified water that has been used, e.g. during washing of wafers, may be collected in a trough/drain 12 and then recirculated back to the water source 6. The trough/drain 12 may comprise appropriate filters to prevent the contaminants/substances added to the water during the washing step to reach the water source 6. The membrane distillation assembly 1 may also comprise a prefilter located between the water source 6 and the water supply unit 3.

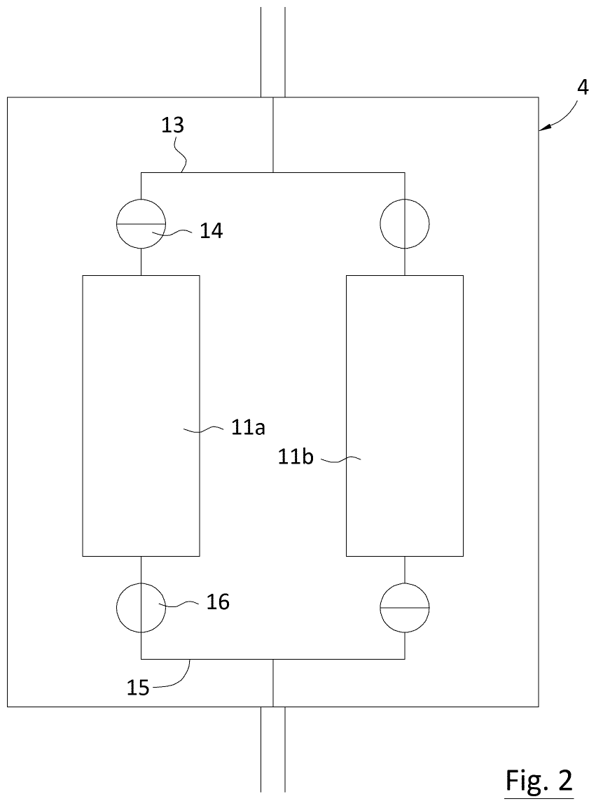

Reference is now made to FIG. 2, disclosing a schematic illustration of the reservoir 4 of the membrane distillation assembly 1 according to a first schematic embodiment.

According to various embodiments, each tank 11a, 11b comprises an intermediate conduit 13 connected to the membrane distiller 2 and having a controllable intermediate valve 14, and an outlet conduit 15 connected to the purified water dispenser tool 5 and having a controllable outlet valve 16. The tanks 11a, 11b are oriented such that the purified water will automatically flow towards the outlet conduit 15 that is connected to the tank at the lowest point of the tank.

In the event the purified water in the first tank 11a is not completely utilized in time, i.e. before the useful life of the purified water in the first tank 11a has ended and/or when the second tank 11b is full, the remaining content of the first tank 11a is discharged/wasted before the purified water of the second tank 11b is utilized. Said discharge/waste may be a manual operation directing the dispenser tool 5 directly into the through/drain 12.

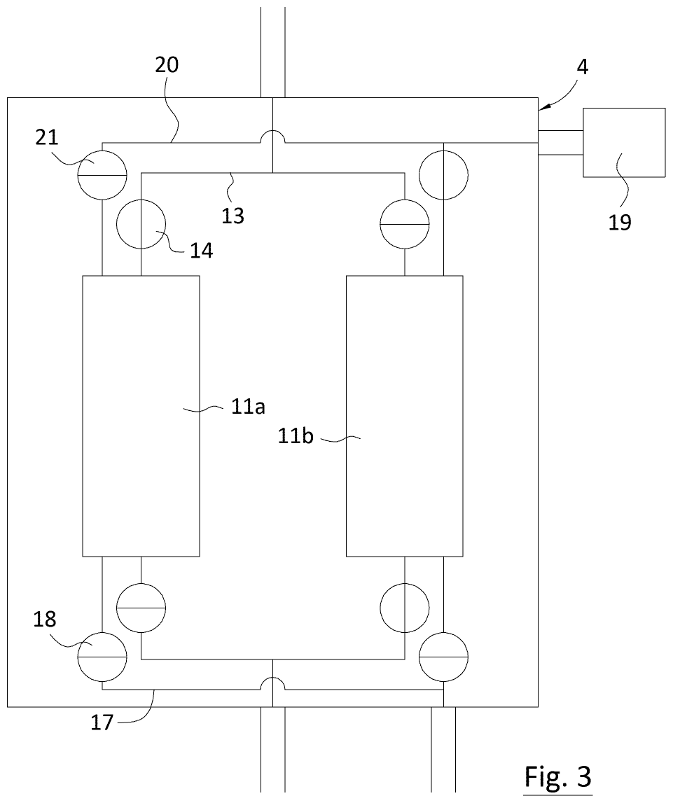

Reference is now also made to FIG. 3, disclosing a schematic illustration of the reservoir 4 of the membrane distillation assembly 1 according to a second schematic embodiment.

According to various embodiments, each tank 11a, 11b comprises a discharge/waste conduit 17 having a controllable discharge valve 18, wherein the discharge conduit 17 bypasses the dispenser tool 5. Using such a solution, the discharge/waste of the surplus content of one tank 11a, 11b may be performed automatically and/or at the same time as the purified water of the other tank 11a, 11b is utilized at the dispenser tool 5. The discharge conduit 17 is preferably connected to the water source 6, directly or indirectly via the through/drain 12.

When the tank 11a, 11b is emptied, it is important that no residues remain in the tank, since such residues may contaminate the next batch of purified water. According to various embodiments, the membrane distillation assembly 1 comprises a gas source 19, preferably nitrogen or the like gas. Each tank 11a, 11b comprises a gas supply conduit 20 that is connected to the gas source 19 and having a controllable gas valve 21. The pressurized gas from the gas source 19 is utilized to empty the tanks 11a, 11b, via the outlet valve 16 and/or the discharge valve 18. The gas supply conduit 20 is preferably connected to the tank 11a, 11b adjacent the intermediate conduit 13 or via the intermediate conduit 13 downstream the intermediate valve 14.

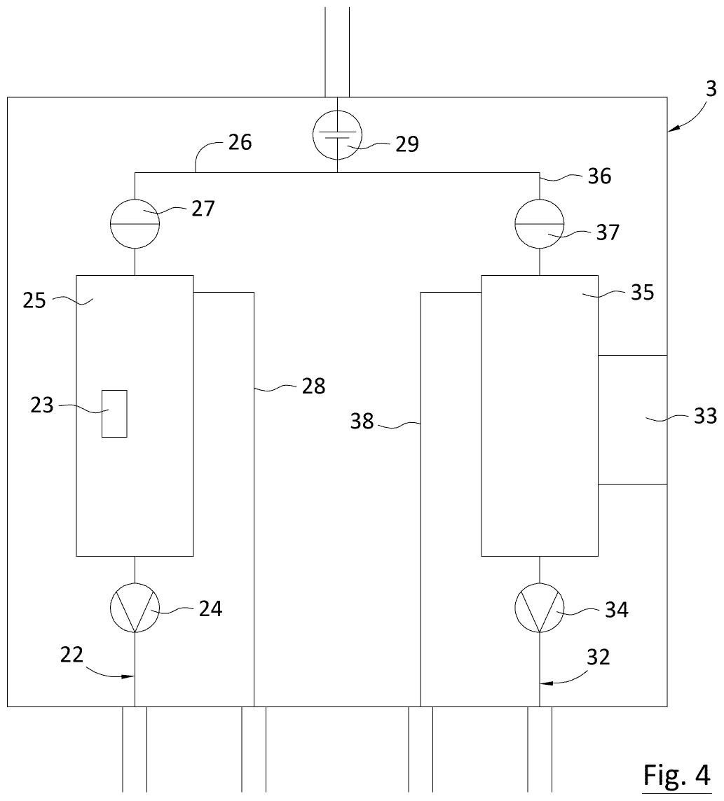

Reference is now also made to FIG. 4, disclosing a schematic illustration of the water supply unit 3 of the membrane distillation assembly 1.

According to various embodiments, the the water supply unit 3 comprises a primary water supply conduit, generally designated 22, connected to the evaporation chamber 7 of the membrane distiller 2, wherein the primary water supply conduit 22 comprises a heater 23. Thus, the water supplied to the evaporation chamber 7 is preheated to the appropriate temperature.

The primary water supply conduit 22 comprises a water regulator 24 configured for controlling the flow and pressure of the water supplied to the evaporation chamber 7 via the primary water supply conduit 22. The water regulator 24 is preferably constituted by a pump that has to be automatically primed in order to prevent too high pressure in the evaporation chamber 7.

According to various embodiments the water supply unit 3 comprises a buffer tank 25 connected to the primary water supply conduit 22. Preferably the buffer tank 25 is associated with the heater 23, but they may also be located in series with each other. Thereto, a feed water conduit 26 is connected to the buffer tank 25 or to the water regulator 24, and is configured to be connected to the water source 6, wherein the feed water conduit 26 comprises a controllable charging valve 27, in order to charge the buffer tank 25 or to prime the water regulator 24. According to various embodiments, the water supply unit 3 comprises a primary water return conduit 28 extending from the evaporation chamber 7 to the buffer tank 25, wherein the water not purified in the membrane distiller 2, i.e. not passing the membrane 9, is returned/recycled which is beneficial since it already has an elevated temperature. The buffer tank 25 preferably comprises a level sensor, in order to control the charging valve 27. The primary water supply conduit 22 preferably comprises an air vent.

The water supply unit 3 comprises a pressure regulator valve 29 in order not to obtain a too high pressure at the upstream side of the water regulator 24. The pressure regulator valve 29 may be located between the water source 6 and the water supply unit 3.

The flow generated by the water regulator 24 is in the range 1-5 litres/minute, and the production of purified water reaching the reservoir 4 is in the range 1-4 litres/minute.

According to various embodiments, the membrane distiller 2 comprises a sealed cooling chamber 30 located adjacent the condensation chamber 8. Thus, the cooling chamber 30 is configured to provide the cold surface 10. Preferably the membrane distiller 2 comprises a film/partition/foil 31 separating the cooling chamber 30 and the condensation chamber 8 from each other, i.e. the cold surface 10 is part of the film/partition 31. The cooling chamber 30 comprises a liquid/water or gas. The cold surface 10 may alternatively be part of a cooling block/device.

According to various embodiments the thickness of the film 31 is equal to or more than 0.08 millimetre and equal to or less than 0.25 millimetre, preferably equal to or more than 0.1 millimetre and equal to or less than 0.2 millimetre. Thereby, the film 31 is able to withstand deformation and is easy to install, and still have a low insulation effect. The cold surface 10 shall be as smooth as possible, in order to facilitate the purified water to flow downwards. Preferably the film 31 is hydrophobic, in order to facilitate the purified water to flow downwards. The film 31 is preferably a hydrophobic material, such as polyvinylidene fluoride [PVDF].

According to various embodiments, the the water supply unit 3 comprises a secondary water supply conduit, generally designated 32, connected to the cooling chamber 30 of the membrane distiller 2, wherein the secondary water supply conduit 32 comprises a cooler 33. Thus, the water in the cooling chamber 30 has an appropriate temperature to efficiently condensate the vapour in the condensation chamber 8 to purified water.

The secondary water supply conduit 32 comprises a water regulator 34 configured for controlling the flow and pressure of the water supplied to the cooling chamber 30 via the secondary water supply conduit 32. The water regulator 34 is preferably constituted by a pump that has to be automatically primed in order to prevent too high pressure in the cooling chamber 30.

According to various embodiments the water supply unit 3 comprises a buffer tank 35 connected to the secondary water supply conduit 32. Preferably the buffer tank 35 is associated with the cooler 33, but they may also be located in series with each other. Thereto, a feed water conduit 36 is connected to the buffer tank 35 or to the water regulator 34, and is configured to be connected to the water source 6, wherein the feed water conduit 36 comprises a controllable charging valve 37, in order to charge the buffer tank 35 or to provide water to the water regulator 34. According to various embodiments, the water supply unit 3 comprises a secondary water return conduit 38 extending from the cooling chamber 30 to the buffer tank 35, wherein the cooling water is returned/recycled which is beneficial since it will decrease the water usage.

The buffer tank 35 preferably comprises a level sensor, in order to control the charging valve 37. The secondary water supply conduit 32 preferably comprises an air vent.

The cooler 33 is preferably a thermoelectric heat pump, such as a Peltiere device, that transfer heat from one side of the device to the other side using electric energy. The heat is transferred from the liquid/water in the secondary water supply conduit 32, preferably the buffer tank 35, to the surrounding air. According to alternative embodiments, such a thermoelectric heat pump is directly associated with the cooling chamber 30.

At least the reservoir 4 and conduits extending from the condensation chamber 8 to the dispenser tool 5 are preferably treated to have hydrophobic surfaces facing the purified water in order facilitate the flow of purified water.

### Feasible Modifications of the Invention

The invention is not limited to only the abovementioned and embodiments shown in the drawings, which only have an illustrating and exemplifying purpose. This patent application is intended to cover all modifications and variants of the preferred embodiments described herein, and the present invention is consequently defined by the wording of the enclosed claims and the equipment can thus be modified in all conceivable ways within the framework of the enclosed claims.

It should also be pointed out that all information about/concerning terms such as above, below, upper, lower, etc. shall be interpreted/read with the equipment oriented in accordance with the figures, with the drawings oriented in such a way that the reference numbers can be read in a correct manner. Consequently, such terms only indicate relative relationships in the shown embodiments, which relationships can be changed if the equipment according to the invention is provided with another construction/design.

It shall also be pointed out that even thus it is not explicitly stated that features from a specific embodiment may be combined with features from another embodiment, the combination shall be considered obvious, if the combination is possible.

1. A membrane distillation assembly for providing purified water, the membrane distillation assembly comprising,
a membrane distiller that is configured for producing purified water, the membrane distiller having an evaporation chamber and a condensation chamber, wherein the evaporation chamber and the condensation chamber are separated from each other by a membrane,
a reservoir connected to the membrane distiller, the reservoir being configured for intermediate storing of purified water,
a water supply unit connected to the membrane distiller, and
a purified water dispenser tool connected to the reservoir,
wherein the reservoir comprises at least two tanks for intermediate storing of purified water, wherein said tanks are connected in parallel with each other between the membrane distiller and the purified water dispenser tool.

2. The membrane distillation assembly according to claim 1, wherein each tank comprises:
an intermediate conduit connected to the membrane distiller and having a controllable intermediate valve, and
an outlet conduit connected to the purified water dispenser tool and having a controllable outlet valve.

3. The membrane distillation assembly according to claim 1, wherein each tank comprises:
a discharge conduit having a controllable discharge valve, wherein the discharge conduit bypasses the dispenser tool.

4. The membrane distillation assembly according to claim 1, wherein the membrane distillation assembly comprises a gas source, each tank comprising:
a gas supply conduit connected to the gas source and having a controllable gas valve.

5. The membrane distillation assembly according to claim 1, wherein the water supply unit comprises:
a primary water supply conduit connected to the evaporation chamber, wherein the primary water supply conduit comprises a heater.

6. The membrane distillation assembly according to claim 5, wherein primary water supply conduit comprises:
a water regulator configured for controlling the flow and pressure of the water supplied to the evaporation chamber via the primary water supply conduit.

7. The membrane distillation assembly according to claim 5, wherein the water supply unit comprises:
a buffer tank connected to the primary water supply conduit, and
a feed water conduit connected to the buffer tank and configured to be connected to a water source, wherein the feed water conduit comprises a controllable charging valve.

8. The membrane distillation assembly according to claim 7, wherein the water supply unit comprises:
a primary water return conduit extending from the evaporation chamber to the buffer tank.

9. The membrane distillation assembly according to claim 1, wherein the membrane distiller comprises a cooling chamber located adjacent the condensation chamber.

10. The membrane distillation assembly according to claim 9, wherein the membrane distiller comprises a film separating the cooling chamber and the condensation chamber from each other.

11. The membrane distillation assembly according to claim 10, wherein the thickness of the film is equal to or more than 0.08 millimetre and equal to or less than 0.25 millimetre, preferably equal to or more than 0.1 millimetre and equal to or less than 0.2 millimetre.

12. The membrane distillation assembly according to claim 9, wherein the water supply unit comprises:
a secondary water supply conduit connected to the cooling chamber, wherein the secondary water supply conduit comprises a cooler.

13. The membrane distillation assembly according to claim 12, wherein secondary water supply conduit comprises:
a water regulator configured for controlling the flow and pressure of the water supplied to the cooling chamber via the secondary water supply conduit.

14. The membrane distillation assembly according to claim 12, wherein the water supply unit comprises:
a buffer tank connected to the secondary water supply conduit, and
a feed water conduit connected to the buffer tank and configured to be connected to a water source, wherein the feed water conduit comprises a controllable charging valve.

15. The membrane distillation assembly according to claim 14, wherein the water supply unit comprises:
a secondary water return conduit extending from the cooling chamber to the buffer tank.
